(19) United States
(12) Patent Application Publication
(10) Pub. No.: US 2025/0186888 A1
(43) Pub. Date: Jun. 12, 2025

(54) METHOD FOR CONTROLLING MOVEMENT OF VIRTUAL OBJECT, ELECTRONIC DEVICE, STORAGE MEDIUM, AND COMPUTER PROGRAM PRODUCT

(71) Applicant: SHANGHAI LILITH TECHNOLOGY CORPORATION, Shanghai (CN)

(72) Inventor: Yining Li, Shanghai (CN)

(21) Appl. No.: 18/806,153

(22) Filed: Aug. 15, 2024

Related U.S. Application Data
(63) Continuation of application No. PCT/CN2024/081906, filed on Mar. 15, 2024.

(30) Foreign Application Priority Data
Dec. 8, 2023 (CN) 202311687523.3

(51) Int. Cl. A63F 13/56; A63F 13/52; A63F 13/573

(52) U.S. Cl. CPC A63F 13/56; A63F 13/52; A63F 13/573

(57) ABSTRACT

A method for controlling movement of virtual object, including a determining step of determining, by a client, relative orientation parameters between a first virtual object on the client and a second virtual object on a server based on a second position-parameter and a second movement parameter of the second virtual object received from the server; a calculating step of calculating, by the client, first movement parameters of the first virtual object, based on the instantaneous distance, the instantaneous angle-difference and the second instantaneous speed; the first movement parameters including a first instantaneous speed and a first instantaneous angular speed of the first virtual object; and a presenting step of controlling, by the client, the first virtual object to move toward the second virtual object based on the first instantaneous speed and the first instantaneous angular speed.

### CROSS-REFERENCE TO RELATED APPLICATIONS

This application is a continuation application of PCT Patent Application No. PCT/CN2024/081906, entitled “Method for Controlling Movement of Virtual Object, Device, Storage medium, and Computer Program Product”, filed on Mar. 15, 2024, which claims priority of Chinese patent application No. 202311687523.3, filed on Dec. 8, 2023, the entire content of which are incorporated herein by reference.

### TECHNICAL FIELD

The application relates to the technical field of game design, and in particular to methods and systems for controlling movement of virtual object, electronic devices, computer-readable storage medium, and computer program products.

### BACKGROUND

During a game, a virtual object may be in a first state before moving, and may be in a second state when moving. For example, in a strategy game, the virtual object hovers around a certain position when it stops moving, and enters a moving state from a hovering state after receiving a movement instruction. However, when the virtual object enters the moving state from the hovering state, changes of angle may cause the problem of stiff trajectory transition and stiff speed transition. When a large number of virtual objects enter moving states from hovering states at the same time, sending movement parameters of the virtual objects relying on a server will cause an excessive computing burden of the server. Therefore, it is necessary to provide a method for controlling movement of virtual object, which can make full use of performance of a client to reduce the computing burden of the server and support a smooth transition of moving states and a smooth transition of moving processes of the virtual object.

### SUMMARY

The purpose of this application is to provide methods for controlling movement of virtual object, electronic devices, computer-readable storage medium, and computer program products, which may make full use of performance of a client to reduce computing burden of a server and may support a smooth movement of the virtual object, thereby more realistically restoring a posture of the virtual object in a real scene.

This application discloses a method for controlling movement of virtual object. The method includes following steps.

In a determining step, a client determines relative orientation parameters between a first virtual object and a second virtual object based on a second position-parameter and a second movement parameter of the second virtual object. The relative orientation parameters include an instantaneous distance and an instantaneous angle-difference between the first virtual object and the second virtual object, and the second movement parameter include a second instantaneous speed of the second virtual object.

In a calculating step, the client calculates first movement parameters of the first virtual object, based on the instantaneous distance, the instantaneous angle-difference and the second instantaneous speed. The first movement parameters include a first instantaneous speed and a first instantaneous angular speed of the first virtual object.

In a presenting step, the client controls the first virtual object to move toward the second virtual object based on the first instantaneous speed and the first instantaneous angular speed.

In some embodiments, the calculating step further includes calculating, by the client, the first instantaneous speed based on a formula: V₁ᵢ=V₂ᵢ+dᵢ×a, where V₁ᵢ denotes the first instantaneous speed, V₂ᵢ denotes the second instantaneous speed, dᵢ denotes the instantaneous distance, and a denotes an acceleration coefficient, and the acceleration coefficient is used as a configuration parameter for adjusting the first instantaneous speed.

In some embodiments, the relative orientation parameters further include a following distance between the first virtual object and the second virtual object. The calculating step further includes, calculating, by the client, the first instantaneous speed based on a formula: V₁ᵢ=V₂ᵢ+(dᵢ−d_{f})×a, where V₁ᵢ denotes the first instantaneous speed, V₂ᵢ denotes the second instantaneous speed, dᵢ denotes the instantaneous distance, a denotes an acceleration coefficient, and d_{f} denotes the following distance, and the acceleration coefficient and the following distance are used as configuration parameters for adjusting the first instantaneous speed.

In some embodiments, the relative orientation parameters further include a following distance between the first virtual object and the second virtual object. The determining step further includes determining, by the client, a first constraint parameter of the first virtual object. The first constraint parameter includes a maximum first instantaneous speed of the first virtual object. The calculating step further includes calculating, by the client, the first instantaneous speed based on a formula: V₁ᵢ=V₂ᵢ+min((dᵢ−d_{f})×a, (V_{1i_max}−V₂ᵢ)), where V₁ᵢ denotes the first instantaneous speed, V₂ᵢ denotes the second instantaneous speed, dᵢ denotes the instantaneous distance, d_{f} denotes the following distance, and a denotes an acceleration coefficient, V_{1i_max} denotes the maximum first instantaneous speed, and a function min((dᵢ−d_{f})×a, (V_{1i_max}−V₂ᵢ)) denotes a smaller one of (dᵢ−d_{f})×a and (V_{1i_max}−V₂ᵢ).

In some embodiments, the relative orientation parameters further include a following distance between the first virtual object and the second virtual object. The determining step further includes determining, by the client, first constraint parameters of the first virtual object, and the first constraint parameters include a maximum first instantaneous speed of the first virtual object and a minimum first instantaneous speed of the first virtual object. The calculating step further includes, calculating, by the client, the first instantaneous speed based on a formula: V₁ᵢ=max((V₂ᵢ+min((dᵢ−d_{f})×a, (V_{1i_max}−V₂ᵢ))), V_{1i_min}), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, V_{1i_min} denotes the minimum first instantaneous speed, a function min((dᵢ−d_{f})×a, (V_{1i_max} V₂ᵢ)) denotes a smaller one of (dᵢ−d_{f})×a and (V_{1i_max}−V₂ᵢ), and a function max((V₂ᵢ+min((dᵢ−d_{f})×a, (V_{1i_max}−V₂ᵢ))), V_{1i_min}) denotes a larger one of (V₂ᵢ+min((dᵢ−d_{f})×a, (V_{1i_max}−V₂ᵢ))) and the minimum first instantaneous speed V_{1i_min}.

In some embodiments, the calculating step further includes, calculating by the client, the first instantaneous angular speed based on a formula: w₁ᵢ=Δaᵢ×s, where w₁ᵢ denotes the first instantaneous angular speed, Δαᵢ denotes the instantaneous angle-difference, and s denotes a steering coefficient, and the steering coefficient is used as a configuration parameter for adjusting the first instantaneous angular speed.

In some embodiments, the determining step further includes determining, by the client, a first constraint parameter of the first virtual object. The first constraint parameter includes a maximum first instantaneous angular speed of the first virtual object. The calculating step further includes, calculating, by the client, the first instantaneous angular speed based on a formula: w₁ᵢ=min(Δαᵢ×s, w_{1i_max}), where w₁ᵢ denotes the first instantaneous angular speed, Δαᵢ denotes the instantaneous angle-difference, s denotes a steering coefficient, w_{1i_max} denotes the maximum first instantaneous angular speed, a function min(Δαᵢ×s, w_{1i_max}) denotes a smaller one of Δαᵢ×s and w_{1i_max}.

In some embodiments, the calculating step further includes calculating, by the client, a first inclination parameter of the first virtual object based on the first instantaneous angular speed. The first inclination parameter includes a first instantaneous inclination-angle of the first virtual object. The presenting step further includes controlling, by the client, the first virtual object to incline toward the second virtual object based on the first instantaneous inclination-angle.

In some embodiments, the calculating step further includes calculating, by the client, the first instantaneous inclination-angle based on a formula: α₁ᵢ=min(w₁ᵢ×c, 90°), where α₁ᵢ denotes the first instantaneous inclination-angle, w₁ᵢ denotes the first instantaneous angular speed, c denotes an inclination coefficient, a function min(w₁ᵢ×c, 90°) denotes a smaller one of w₁ᵢ×c and 90°, and the inclination coefficient is used as a configuration parameter for adjusting the first instantaneous inclination-angle.

In some embodiments, the second position-parameter includes a second instantaneous position of the second virtual object. The determining step further includes following steps.

At every moment, the client determines a first instantaneous position and a first instantaneous orientation of the first virtual object, and the first instantaneous orientation is a facing direction of a head of the first virtual object.

The client determines the instantaneous distance and an instantaneous relative orientation between the first virtual object and the second virtual object based on the first instantaneous position of the first virtual object and the second instantaneous position of the second virtual object at a current moment. The instantaneous relative orientation is an orientation formed by a straight line connected between the first virtual object and the second virtual object.

The client determines the instantaneous angle-difference between the first virtual object and the second virtual object, based on the first instantaneous orientation of the first virtual object and the relative instantaneous orientation between the first virtual object and the second virtual object at the current moment. The instantaneous angle-difference is an angle formed by the first instantaneous orientation and the relative instantaneous orientation.

In some embodiments, the determining step further includes determining, by the client, the following distance based on a determination rule preset in a game program executed on the client.

In some embodiments, the determining step further includes determining a maximum moving speed of the first virtual object as the maximum first instantaneous speed thereof, and determining a minimum moving speed of the first virtual object as the minimum first instantaneous speed thereof.

In some embodiments, the determining step further includes determining a maximum rotation angular speed of the first virtual object as the maximum first instantaneous angular speed thereof.

The present application discloses a system for controlling movement of virtual object, and the system includes: a determining circuit, a calculation circuit, and a presenting circuit.

The determining circuit is configured to determine relative orientation parameters between a first virtual object and a second virtual object based on a second position-parameter and a second movement parameter of the second virtual object. The relative orientation parameters include an instantaneous distance and an instantaneous angle-difference between the first virtual object and the second virtual object, and the second movement parameter includes a second instantaneous speed of the second virtual object.

The calculation circuit is configured to calculate the first movement parameters of the first virtual object, based on the instantaneous distance, the instantaneous angle-difference and the second instantaneous speed. The first movement parameters include the first instantaneous speed and the first instantaneous angular speed of the first virtual object.

The presenting circuit is configured to control the first virtual object to move toward the second virtual object based on the first instantaneous speed and the first instantaneous angular speed.

In some embodiments, the calculation circuit is further configured to calculate the first instantaneous speed based on the following formula: V₁ᵢ=V₂ᵢ+dᵢ×a, where V₁ᵢ denotes the first instantaneous speed, V₂ᵢ denotes the second instantaneous speed, dᵢ denotes the instantaneous distance, and a denotes an acceleration coefficient. The acceleration coefficient is used as a configuration parameter for adjusting the first instantaneous speed.

In some embodiments, the relative orientation parameters further include a following distance between the first virtual object and the second virtual object. The calculation circuit is further configured to calculate the first instantaneous speed based on the following formula: V₁ᵢ=V₂ᵢ+(dᵢ−d_{f})×a, where V₁ᵢ denotes the first instantaneous speed, V₂ᵢ denotes the second instantaneous speed, dᵢ denotes the instantaneous distance, d_{f} denotes the following distance, and a denotes the acceleration coefficient. The following distance is used as a configuration parameter for adjusting the first instantaneous speed.

In some embodiments, the determining circuit is further configured to determine a first constraint parameter of the first virtual object. The first constraint parameter includes the maximum first instantaneous speed of the first virtual object. The calculation circuit is further configured to calculate the first instantaneous speed based on the following formula: V₁ᵢ=V₂ᵢ+min((dᵢ−d_{f})×a, (V_{1i_max}−V₂ᵢ)), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, the function min((dᵢ−d_{f})×a, (V_{1i_max}−V₂ᵢ)) denotes the smaller one of (dᵢ−d_{f})×a and (V_{1i_max}−V₂ᵢ).

In some embodiments, the first constraint parameter further includes the minimum first instantaneous speed of the first virtual object. The calculation circuit is further configured to calculate the first instantaneous speed based on the following formula: V₁ᵢ=max((V₂ᵢ+min((dᵢ−d_{f})×a, (V_{1i_max}−V₂ᵢ))), V_{1i_min}), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, V_{1i_min} denotes the minimum first instantaneous speed, the function max((V₂ᵢ+min((dᵢ−d_{f})×a, (V_{1i_max}−V₂ᵢ))), V_{1i_min}) denotes the larger one of (V₂ᵢ+min((dᵢ−d_{f})×a, (V_{1i_max}−V₂ᵢ))) and the minimum first instantaneous speed V_{1i_min}.

In some embodiments, the calculation circuit is further configured to calculate the first instantaneous angular speed based on the following formula: w₁ᵢ=Δαᵢ×s, where w₁ᵢ denotes the first instantaneous angular speed, Δαᵢ denotes an instantaneous angle-difference, s denotes a steering coefficient, and the steering coefficient is used as a configuration parameter for adjusting the first instantaneous angular speed.

In some embodiments, the determining circuit is further configured to determine the first constraint parameter of the first virtual object, and the first constraint parameter includes the maximum first instantaneous angular speed of the first virtual object. The calculation circuit 303 is further configured to calculate the first instantaneous angular speed based on the following formula: w₁ᵢ=min(Δαᵢ×s, w_{1i_max}), where w₁ᵢ denotes the first instantaneous angular speed, Δαᵢ denotes the instantaneous angle-difference, s denotes the steering coefficient, w_{1i_max} denotes the maximum first instantaneous angular speed, the function min(Δαᵢ×s, w_{1i_max}) denotes the smaller one of Δαᵢ×s and w_{1i_max}.

In some embodiments, the calculation circuit is further configured to calculate a first inclination parameter of the first virtual object based on the first instantaneous angular speed. The first inclination parameter includes a first instantaneous inclination-angle of the first virtual object. The presenting circuit is further configured to control the first virtual object to incline toward the second virtual object based on the first instantaneous inclination-angle.

In some embodiments, the calculation circuit is further configured to calculate the first instantaneous inclination-angle based on the following formula: α₁ᵢ=min(w₁ᵢ×c, 90°), where alt denotes the first instantaneous inclination-angle, w₁ᵢ denotes the first instantaneous angular speed, c denotes an inclination coefficient, min(w₁ᵢ× c, 90°) denotes the smaller one of w₁ᵢ×c and 90°. The inclination coefficient is used as a configuration parameter for adjusting the first instantaneous inclination-angle.

The present application discloses an electronic device. The electronic device is the client and incudes a processor and a memory storing computer-executable instructions. The processor is configured to execute the computer-executable instructions to perform the method for controlling movement of virtual object above.

The present application discloses a non-transitory computer-readable storage medium, having computer-executable instructions stored thereon. The computer-executable instructions, when executed by a processor, cause the processor to perform the method for controlling movement of virtual object above.

The present application discloses a computer program product, including computer-executable instructions. The computer-executable instructions, when executed by a processor, cause the processor to perform the method for controlling movement of virtual object above.

Compared with the prior art, the embodiments of the present application have differences and effects as follows.

According to the method for controlling movement of virtual object in the embodiments of the present application, for the movement instruction instructing to move the first virtual object hovering around the first position to the second position, on the one hand, the execution result of the movement instruction on the server may be simplified as moving the second virtual object directly from the first position to the second position without considering the state switching of the first virtual object and the trajectory transition and speed transition processes caused thereby, thus greatly reducing the computing burden of the server, and greatly reducing the communication data between the server and the client. On the other hand, the execution result of the movement instruction on the client may be understood as controlling the first virtual object to move towards the second virtual object (or may be understood as controlling the first virtual object to chase the second virtual object), and ensuring that the trajectory transition process and the speed transition process are as smooth as possible during the movement.

### BRIEF DESCRIPTION OF THE DRAWINGS

FIG. 1 shows an application scenario of a method for controlling movement of virtual object according to an embodiment of the present application.

FIG. 2 is a flow chart of the method for controlling movement of virtual object according to an embodiment of the present application.

FIG. 3 shows a movement control of a virtual object according to an embodiment of the present application.

FIG. 4 is a schematic structural view showing a system for controlling movement of virtual object according to an embodiment of the present application.

FIG. 5 is a schematic block diagram showing a hardware structure of an electronic device performing the method for controlling movement of virtual object according to an embodiment of the present application.

### DETAILED DESCRIPTION OF THE EMBODIMENTS

In order to make the purpose, technical solutions and advantages of the embodiments of the present application clearer, the solutions of the embodiments of the present application will be further described in detail hereinafter with reference to the accompanying drawings. Obviously, the described embodiments are part of but not all the embodiments of the present application. Based on the described embodiments of the present application, all other embodiments obtained by ordinary skilled in the art without creative work are within the protection scope of the present application.

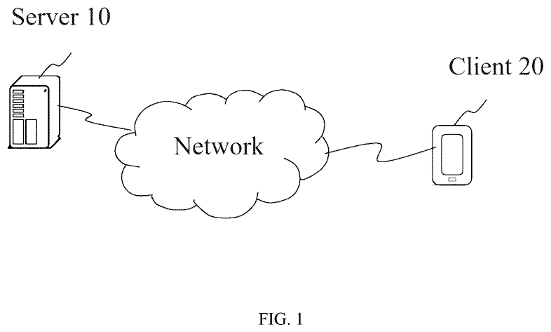

FIG. 1 shows an application scenario of a method for controlling movement of virtual object according to an embodiment of the present application. The application scenario, to which the method of the present application is applied, may include a server 10 and a client 20. Data are transmitted between the server 10 and the client 20 via a communication network. The server 10 may receive real-time data sent by the client 20. The server 10 and the client 20 each may be an electronic device that includes a storage device storing computer-executable instructions and a processor, specifically, may be a mobile phone, a tablet, an e-reader, a laptop, or a desktop computer, etc.

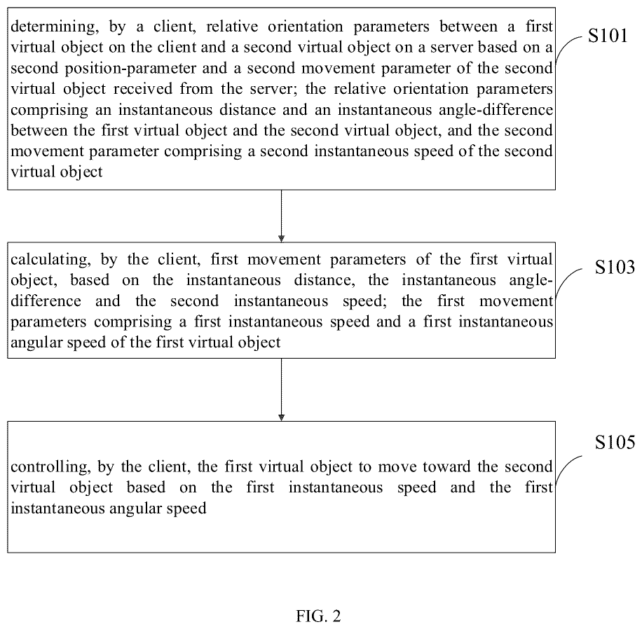

FIG. 2 is a flow chart of the method for controlling movement of virtual object according to an embodiment of the present application. As shown in FIG. 2, an embodiment of the method for controlling movement of virtual object includes steps S101, S103 and S105.

In a determining step S101, the client 20 determines relative orientation parameters between a first virtual object and a second virtual object based on a second position-parameter and a second movement parameter. The relative orientation parameters include an instantaneous distance and an instantaneous angle-difference between the first virtual object and the second virtual object, and the second movement parameter includes a second instantaneous speed of the second virtual object.

The first virtual object may refer to a controllable object in a game program executed on the client 20, and include a virtual character, and a virtual prop, etc. For example, for a single fighter or a fighter formation operated in a unified manner in a war game, the fighter or the fighter formation may be selected as the first virtual object through an input device of the client electronic device (also referred to as “the client” 20 in this application), such as a touch screen of a smart phone. In an embodiment, the first virtual object may also refer to a controllable object in a game program executed on the server 10. When receiving a movement instruction such as an instruction for moving the fighter or the fighter formation, the client 20 may determine that the fighter or the fighter formation is the first virtual object to be moved. For the sake of simplicity, the following description of movement control is based on the single fighter, but it should be understood that a movement of the fighter formation operated in a unified manner may also be controlled similarly, which will not be repeated herein. Before moving, the first virtual object may be in a first state, and when moving, the first virtual object may be in a second state. For example, before moving, the fighter may be in a hovering state, i.e., a state of making a circular motion around a certain position in the map. When moving, the fighter may be in a moving state, i.e., when receiving the movement instruction, the fighter is controlled to move from a current position to a target position.

The second virtual object may refer to a logical object on the server 10, which corresponds to the controllable object in the game program executed on the client 20. The server 10 may determine a position of the second virtual object based on a determination rule preset in the game program executed on the client 20. In this application, the position of the second virtual object is also referred to as a logical position. For example, the determination rule may be that when the fighter is hovering, the second virtual object is located at the center of the circle along which the fighter is hovering, that is, when the fighter is hovering, the center of the circle is the logical position. In an embodiment, the second virtual object may also refer to a logical object on the client 20.

When the client 20 receives a movement instruction for the first virtual object, which is issued in a manner of, for example, a user operating to move the first virtual object on the client to the target location, the client 20 sends the movement instruction to the server 10. In response to the movement instruction, the server 10 determines the second position-parameter and the second movement parameter of the second virtual object, and moves the second virtual object, and sends the second position-parameter and the second movement parameter of the second virtual object to the client 20. In an embodiment, the second position-parameter and the second movement parameter of the second virtual object may be synchronized by another client 20. The client 20 determines the relative orientation parameters between the first virtual object and the second virtual object based on the second position-parameter and the second movement parameter of the second virtual object, and further calculates a first movement parameter of the first virtual object, and moves the first virtual object. In this case, for the movement instruction for moving the first virtual object hovering around the first position to the second position, on one hand, an execution result of the movement instruction on the server 10 may be simplified as moving the second virtual object directly from the first position to the second position without considering the state switching of the first virtual object and the trajectory transition and speed transition processes caused thereby. It may be seen that the computing burden of the server 10 is greatly reduced.

At every moment, the server 10 may determine the second instantaneous position and the second instantaneous speed of the second virtual object. The second instantaneous position of the second virtual object is included in the second position-parameter of the second virtual object, and the second instantaneous speed of the second virtual object is included in the second movement parameter of the second virtual object.

In some embodiments, the second virtual object moves from the first position to the second position at a constant speed, so the second instantaneous speed of the second virtual object is the same at different times. The server 10 may determine the second instantaneous speed based on the determination rule preset in the game program executed on the client 20. For example, the determination rule may be that reference moving speeds of various fighters are determined as corresponding second instantaneous speeds thereof.

In addition, the server 10 may send the second instantaneous position and the second instantaneous speed of the second virtual object at a current moment to the client 20 regularly or irregularly, and communication data between the server 10 and the client 20 are greatly reduced, so as to prevent the client 20 from being unable to smoothly control the movement of the virtual object in a case of a network delay. In some embodiments, the parameters may be synchronized between the server 10 and the client 20 based on a frame, that is, the data are synchronized once per frame, and a duration of each frame, such as one millisecond, ten milliseconds, one second, etc., may be defined according to the specific application scenario.

It may be understood that the server 10 may determine a moving route from the first position to the second position by using an existing path-finding algorithm, so that the second virtual object moves from the first position to the second position at a uniform speed, which will not be described in detail herein.

On the other hand, an execution result of the movement instruction on the client 20 may be understood as controlling the first virtual object to move toward the second virtual object (or may also be understood as controlling the first virtual object to chase the second virtual object), and ensuring that the trajectory transition process and the speed transition process are as smooth as possible during the movement. The above calculation process is implemented and the execution result is shown on the client 20, thereby reducing the calculation burden of the server 10, and presenting a smooth and an intuitive movement trajectory on the client 20 to the user.

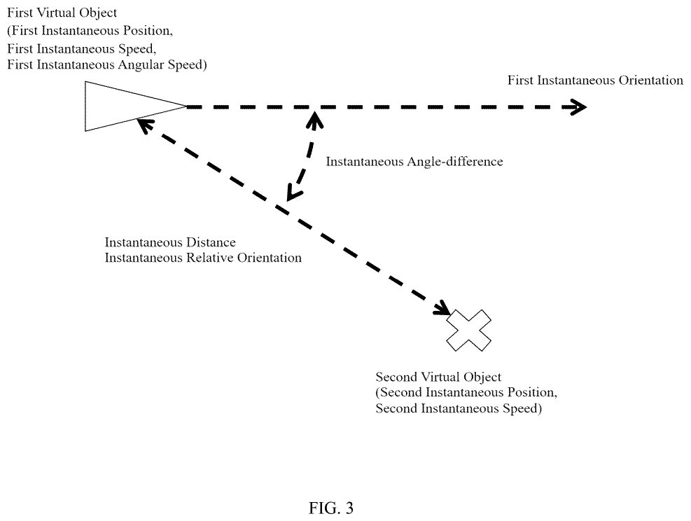

FIG. 3 shows a movement control of a virtual object according to an embodiment of the present application. As shown in FIG. 3, first, at every moment, the client 20 may determine the first instantaneous position and the first instantaneous orientation of the first virtual object. The first instantaneous orientation refers to a facing direction of the head of the first virtual object. For example, when the first virtual object is a fighter, the facing direction of the head of the fighter is the first instantaneous orientation. The first instantaneous position and the first instantaneous orientation of the first virtual object are included in the first position-parameters of the first virtual object.

Then the client 20 determines the instantaneous distance and the instantaneous relative orientation between the first virtual object and the second virtual object based on the first instantaneous position of the first virtual object and the second instantaneous position of the second virtual object at the current moment. The instantaneous distance refers to a straight-line distance or a Euclidean distance between the first virtual object and the second virtual object, and the instantaneous relative orientation refers to an orientation formed by a straight line connected between the first virtual object and the second virtual object. The instantaneous distance and the relative instantaneous orientation between the first virtual object and the second virtual object are included in the relative orientation parameters between the first virtual object and the second virtual object.

Then, the client 20 determines an instantaneous angle-difference between the first virtual object and the second virtual object, based on the first instantaneous orientation of the first virtual object and the relative instantaneous orientation between the first virtual object and the second virtual object at the current moment. The instantaneous angle-difference refers to an angle formed by the first instantaneous orientation and the relative instantaneous orientation. The instantaneous angle-difference between the first virtual object and the second virtual object is included in the relative orientation parameters between the first virtual object and the second virtual object.

In the calculating step S103, based on the instantaneous distance, the instantaneous angle-difference and the second instantaneous speed, the client 20 calculates the first movement parameters of the first virtual object, the first movement parameters include the first instantaneous speed and the first instantaneous angular speed of the first virtual object.

In some embodiments, the calculating step S103 further includes calculating, by the client 20, the first instantaneous speed based on the following formula: V₁ᵢ=V₂ᵢ+dᵢ×a, where V₁ᵢ denotes the first instantaneous speed, V₂ᵢ denotes the second instantaneous speed, dᵢ denotes the instantaneous distance, and a denotes an acceleration coefficient. The acceleration coefficient a is used as a configuration parameter for adjusting the first instantaneous speed V₁ᵢ. It can be seen that, when the second instantaneous speed V₂ᵢ and the acceleration coefficient a remain unchanged, the first instantaneous speed V₁ᵢ of the first virtual object linearly slows down as the instantaneous distance dᵢ between the first virtual object and the second virtual object becomes shorter, such that the first virtual object approaches the second virtual object from fast to slow, thereby smoothing the speed transition process. In this embodiment, the fighter approaches the logical position of the logical object from fast to slow.

In some embodiments, the relative orientation parameters further include a following distance between the first virtual object and the second virtual object. The client 20 may determine the following distance based on the determination rule preset in the game program executed on the client. For example, the determination rule may be that when the fighter hovers, the radius of the hovering is determined as the following distance.

In this case, the calculating step S103 further includes calculating, by the client 20, the first instantaneous speed based on the following formula: V₁ᵢ=V₂ᵢ+(dᵢ−d_{f})×a, where V₁ᵢ denotes the first instantaneous speed, V₂ᵢ denotes the second instantaneous speed, dᵢ denotes the instantaneous distance, d_{f} denotes the following distance, and a denotes the acceleration coefficient. The following distance d_{f} is used as a configuration parameter for adjusting the first instantaneous speed V₁ᵢ. It can be seen that, when the second instantaneous speed V₂ᵢ and the acceleration coefficient a remain unchanged, the first instantaneous speed V₁ᵢ of the first virtual object slows down linearly as the instantaneous distance dᵢ between the first virtual object and the second virtual object approximates to the following distance d_{f}, so that the first virtual object approaches the second virtual object from fast to slow, thereby smoothing the speed transition process, and allowing the first virtual object to transit to a subsequent post-movement action, thereby smoothing the trajectory transition process. In this embodiment, the fighter approaches the logical position of the logical object from fast to slow, and the fighter is allowed to transit to the post-movement action of hovering around the logical position.

In some embodiments, the determining step S101 further includes determining, by the client 20, a first constraint parameter of the first virtual object. The first constraint parameter includes the maximum first instantaneous speed of the first virtual object. The client 20 may determine the maximum first instantaneous speed based on the determination rule preset in the game program executed on the client. For example, the determination rule may be that the maximum moving speed of each of various fighters is determined as the corresponding maximum first instantaneous speed thereof.

In this case, the calculating step S103 further includes calculating, by the client 20, the first instantaneous speed based on the following formula: V₁ᵢ=V₂ᵢ+min((dᵢ−d_{f})×a, (V_{1i_max}−V₂ᵢ)), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, the function min((dᵢ−d_{f})×a, (V_{1i_max}−V₂ᵢ)) denotes the smaller one of (dᵢ−d_{f})×a and (V_{1i_max}−V₂ᵢ). In other words, the smaller one of (dᵢ−d_{f})×a and (V_{1i_max}−V₂ᵢ) is added to the second instantaneous speed V₂ᵢ to obtain the first instantaneous speed V₁ᵢ, thus limiting an upper limit of the first instantaneous speed V₁ᵢ to prevent the first virtual object from moving too fast, thereby smoothing the speed transition process.

In some embodiments, the first constraint parameter further includes the minimum first instantaneous speed of the first virtual object. The client 20 can determine the minimum first instantaneous speed based on the determination rules preset in the game program executed on the client 20. For example, the determination rule may be that the minimum moving speed of each of various fighters is determined as the corresponding minimum first instantaneous speed thereof. If the first instantaneous speed of the fighter is less than the corresponding minimum first instantaneous speed, the fighter will show a hovering-like posture because it moves too slowly.

In this case, the calculating step S103 further includes calculating, by the client 20, the first instantaneous speed based on the following formula: V₁ᵢ=max((V₂ᵢ+min((dᵢ−d_{f})×a, (V_{1i_max}−V₂ᵢ))), V_{1i_min}), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, V_{1i_min} denotes the minimum first instantaneous speed, the function max((V₂ᵢ+min((dᵢ−d_{f})×a, (V_{1i_max}−V₂ᵢ))), V_{1i_min}) denotes the larger one of (V₂ᵢ+min((dᵢ−d_{f})×a, (V_{1i_max}−V₂ᵢ))) and the minimum first instantaneous speed V_{1i_min}. In other words, the larger one of (V₂ᵢ+min((dᵢ−d_{f})×a, (V_{1i_max}−V₂ᵢ))) and the minimum first instantaneous speed V_{1i_min} is selected to obtain the first instantaneous speed, thus limiting a lower limit of the first instantaneous speed to prevent the fighter from showing the hovering-like posture, thereby smoothing the speed transition process.

In some embodiments, the calculating step S103 further includes calculating, by the client 20, the first instantaneous angular speed based on the following formula: w₁ᵢ=Δαᵢ×s, where w₁ᵢ denotes the first instantaneous angular speed, Δαᵢ denotes an instantaneous angle-difference, s denotes a steering coefficient, and the steering coefficient s is used as a configuration parameter for adjusting the first instantaneous angular speed.

It can be seen that, while the steering coefficient s remains unchanged, the first instantaneous angular speed w₁ᵢ of the first virtual object becomes slows down linearly as the instantaneous angle-difference Δαᵢ between the first virtual object and the second virtual object becomes smaller, causing the first virtual object to rotate itself from fast to slow to face the second virtual object, thus smoothing the trajectory transition process. In this embodiment, the fighter rotates itself from fast to slow to face the logical position of the logical object.

In some embodiments, the determining step S101 further includes determining, by the client 20, the first constraint parameter of the first virtual object, and the first constraint parameter includes the maximum first instantaneous angular speed of the first virtual object. The client 20 may determine the maximum first instantaneous angular speed based on the determination rule preset in the game program executed on the client. For example, the determination rule may be that the maximum rotation angular speed of each of various fighters is determined as the corresponding maximum first instantaneous angular speed thereof.

In this case, the calculating step S103 further includes calculating, by the client 20, the first instantaneous angular speed based on the following formula: w₁ᵢ=min(Δαᵢ×S, w_{1i_max}), where w₁ᵢ denotes the first instantaneous angular speed, Δαᵢ denotes the instantaneous angle-difference, s denotes the steering coefficient, w_{1i_max} denotes the maximum first instantaneous angular speed, the function min(Δαᵢ×s, w_{1i_max}) denotes the smaller one of Δαᵢ×s and w_{1i_max}. In other words, the smaller one of Δαᵢ×s and the maximum first instantaneous angular speed w_{1i_max} is selected to obtain the first instantaneous angular speed w₁ᵢ, thus limiting the upper limit of the first instantaneous angular speed w₁ᵢ to prevent the first virtual object from rotating too fast, thereby smoothing the trajectory transition process.

In a presenting step S105, based on the first instantaneous speed and the first instantaneous angular speed, the client 20 controls the first virtual object to move toward the second virtual object.

Returning to FIG. 3, the client 20 controls the first virtual object to move toward the second virtual object based on the first instantaneous speed and the first instantaneous angular speed of the first virtual object at the current moment, which can support a smooth object movement, thereby more realistically restoring the posture of the object in the real scene. For example, smooth and natural speed and trajectory transitions of a fighter may be achieved when the fighter enters the moving state from the hovering state, thereby restoring the flight posture of the fighter in the real scene.

In some embodiments, the calculating step S103 further includes calculating, by the client 20, a first inclination parameter of the first virtual object based on the first instantaneous angular speed. The first inclination parameter includes a first instantaneous inclination-angle of the first virtual object.

In this case, the presenting step S105 further includes controlling, by the client 20, the first virtual object to incline toward the second virtual object based on the first instantaneous inclination-angle.

In this embodiment, the fighter inclines at a certain angle while moving toward the logical position of the logical object. This angle changes in real time according to the first instantaneous angular speed of the fighter, which can restore the steering posture of the fighter in the real scene and save additional animation resources due to no need to animate inclinations at different angles in advance.

In some embodiments, the first instantaneous inclination-angle is calculated by the client 20 based on the following formula: α₁ᵢ=min(w₁ᵢ×c, 90°), where α₁ᵢ denotes the first instantaneous inclination-angle, w₁ᵢ denotes the first instantaneous angular speed, c denotes an inclination coefficient, a function min(w₁ᵢ×c, 90°) denotes the smaller one of w₁ᵢ×c and 90°. The inclination coefficient c is used as a configuration parameter for adjusting the first instantaneous inclination-angle α₁ᵢ. In other words, if w₁ᵢ×c is greater than 90°, the first instantaneous inclination-angle α₁ᵢ can only be 90°, such that the first virtual object will not incline overly, thereby more realistically restoring the steering posture of the fighter in the real scene.

To sum up, according to the method for controlling movement of virtual object in the embodiments of the present application, for the movement instruction instructing to move the first virtual object hovering around the first position to the second position, on the one hand, the execution result of the movement instruction on the server 10 may be simplified as moving the second virtual object directly from the first position to the second position without considering the state switching of the first virtual object and the trajectory transition and speed transition processes caused thereby, thus greatly reducing the computing burden of the server 10, and greatly reducing the communication data between the server 10 and the client 20. On the other hand, the execution result of the movement instruction on the client 20 may be understood as controlling the first virtual object to move towards the second virtual object (or may be understood as controlling the first virtual object to chase the second virtual object), and ensuring that the trajectory transition process and the speed transition process are as smooth as possible during the movement.

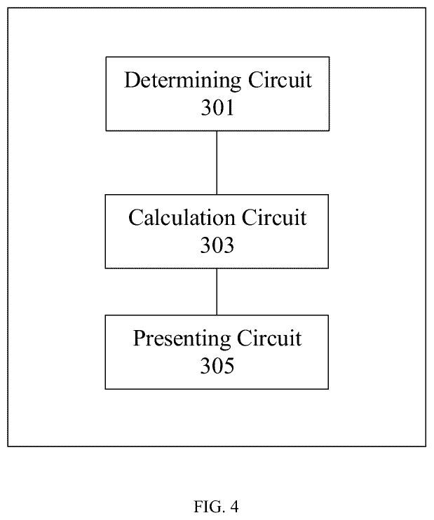

FIG. 4 is a schematic structural view showing a system for controlling movement of virtual object according to an embodiment of the present application. As shown in FIG. 4, the system for controlling movement of virtual object includes: a determining circuit 301, a calculation circuit 303, and a presenting circuit 305.

The determining circuit 301 is configured to determine relative orientation parameters between a first virtual object and a second virtual object based on a second position-parameter and a second movement parameter of the second virtual object. The relative orientation parameters include an instantaneous distance and an instantaneous angle-difference between the first virtual object and the second virtual object, and the second movement parameter includes a second instantaneous speed of the second virtual object.

The calculation circuit 303 is configured to calculate the first movement parameters of the first virtual object, based on the instantaneous distance, the instantaneous angle-difference and the second instantaneous speed. The first movement parameters include the first instantaneous speed and the first instantaneous angular speed of the first virtual object.

The presenting circuit 305 is configured to control the first virtual object to move toward the second virtual object based on the first instantaneous speed and the first instantaneous angular speed.

In some embodiments, the calculation circuit 303 is further configured to calculate the first instantaneous speed based on the following formula: V₁ᵢ=V₂ᵢ+dᵢ×a, where V₁ᵢ denotes the first instantaneous speed, V₂ᵢ denotes the second instantaneous speed, dᵢ denotes the instantaneous distance, and a denotes an acceleration coefficient. The acceleration coefficient a is used as a configuration parameter for adjusting the first instantaneous speed V₁ᵢ.

In some embodiments, the relative orientation parameters further include a following distance between the first virtual object and the second virtual object. The calculation circuit 303 is further configured to calculate the first instantaneous speed based on the following formula: V₁ᵢ=V₂ᵢ+(dᵢ−d_{f})×a, where V₁ᵢ denotes the first instantaneous speed, V₂ᵢ denotes the second instantaneous speed, dᵢ denotes the instantaneous distance, d_{f} denotes the following distance, and a denotes the acceleration coefficient. The following distance d_{f} is used as a configuration parameter for adjusting the first instantaneous speed V₁ᵢ.

In some embodiments, the determining circuit 301 is further configured to determine a first constraint parameter of the first virtual object. The first constraint parameter includes the maximum first instantaneous speed of the first virtual object. The calculation circuit 303 is further configured to calculate the first instantaneous speed based on the following formula: V₁ᵢ=V₂ᵢ+min((dᵢ−d_{f})×a, (V_{1i_max}−V₂ᵢ)), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, the function min((dᵢ−d_{f})×a, (V_{1i_max}−V₂ᵢ)) denotes the smaller one of (dᵢ−d_{f})×a and (V_{1i_max}−V₂ᵢ).

In some embodiments, the first constraint parameter further includes the minimum first instantaneous speed of the first virtual object. The calculation circuit 303 is further configured to calculate the first instantaneous speed based on the following formula: V₁ᵢ=max((V₂ᵢ+min((dᵢ−d_{f})×a, (V_{1i_max}−V₂ᵢ))), V_{1i_min}), where V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, V_{1i_min} denotes the minimum first instantaneous speed, the function max((V₂ᵢ+min((dᵢ−d_{f})×a, (V_{1i_max}−V₂ᵢ))), V_{1i_min}) denotes the larger one of (V₂ᵢ+min((dᵢ−d_{f})×a, (V_{1i_max}−V₂ᵢ))) and the minimum first instantaneous speed V_{1i_min}.

In some embodiments, the calculation circuit 303 is further configured to calculate the first instantaneous angular speed based on the following formula: w₁ᵢ=Δαᵢ×s, where w₁ᵢ denotes the first instantaneous angular speed, Δαᵢ denotes an instantaneous angle-difference, s denotes a steering coefficient, and the steering coefficient s is used as a configuration parameter for adjusting the first instantaneous angular speed.

In some embodiments, the determining circuit 301 is further configured to determine the first constraint parameter of the first virtual object, and the first constraint parameter includes the maximum first instantaneous angular speed of the first virtual object. The calculation circuit 303 is further configured to calculate the first instantaneous angular speed based on the following formula: w₁ᵢ=min(Δαᵢ×s, w_{1i_max}), where w₁ᵢ denotes the first instantaneous angular speed, Δαᵢ denotes the instantaneous angle-difference, s denotes the steering coefficient, w_{1i_max} denotes the maximum first instantaneous angular speed, the function min(Δαᵢ×s, w_{1i_max}) denotes the smaller one of Δαᵢ×s and w_{1i_max}

In some embodiments, the calculation circuit 303 is further configured to calculate a first inclination parameter of the first virtual object based on the first instantaneous angular speed. The first inclination parameter includes a first instantaneous inclination-angle of the first virtual object. The presenting circuit 305 is further configured to control the first virtual object to incline toward the second virtual object based on the first instantaneous inclination-angle.

In some embodiments, the calculation circuit 303 is further configured to calculate the first instantaneous inclination-angle based on the following formula: @1=min(w₁ᵢX c,) 90°, where α₁ᵢ denotes the first instantaneous inclination-angle, w₁ᵢ denotes the first instantaneous angular speed, c denotes an inclination coefficient, min(w₁ᵢ×c, 90°) denotes the smaller one of w₁ᵢ×c and 90°. The inclination coefficient c is used as a configuration parameter for adjusting the first instantaneous inclination-angle α₁ᵢ.

The first embodiment is a method implementation corresponding to this embodiment, and this embodiment may be implemented in cooperation with the first embodiment. The relevant technical details described in the first embodiment are still applicable to this embodiment, and will not be described repeatedly. Correspondingly, the relevant technical details described in this embodiment may also be applied to the first embodiment.

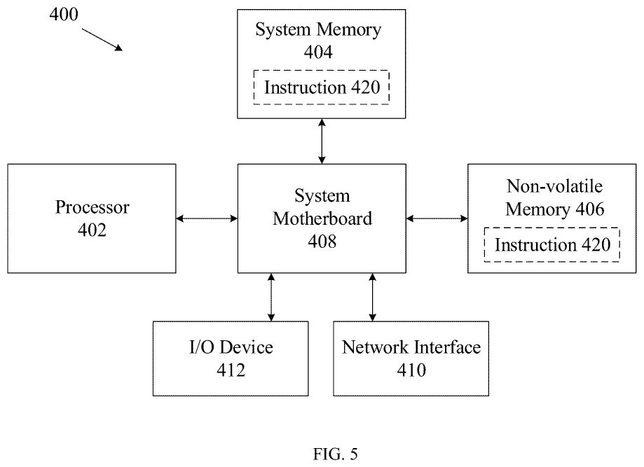

FIG. 5 is a schematic block diagram showing a hardware structure of an electronic device performing the method for controlling movement of virtual object according to an embodiment of the present application.

As shown in FIG. 5, an electronic device 400 may be a client 20, including one or more processors 402, a system motherboard 408 connected to at least one of the processors 402, a system memory 404 connected to the system motherboard 408, and a non-volatile memory (NVM) 406 connected to the system motherboard 408, and a network interface 410 connected to the system motherboard 408.

The processor 402 may include one or more single-core or multi-core processors. The processor 402 may include any combination of a general-purpose processor and special-purpose processors (e.g., a graphics processor, an application processor, a baseband processor, etc.). In the embodiments of the present application, the processor 402 may be configured to perform one or more embodiments shown in FIGS. 2 to 4.

In some embodiments, the system motherboard 408 may include any suitable interface controller to provide a suitable interface for at least one of the processors 402 and/or for any suitable device or component in communication with the system motherboard 408.

In some embodiments, the system motherboard 408 may include one or more memory controllers, thus providing an interface connected to the system memory 404. The system memory 404 may be used to load and store data and/or instructions. In some embodiments, the system memory 404 of the electronic device 400 may include any suitable volatile memory, such as suitable dynamic random-access memory (DRAM).

The NVM 406 may include one or more tangible, non-transitory computer-readable storage medium for storing data and/or instructions. In some embodiments, The NVM 406 may include at least one of any suitable non-volatile memory such as flash memory and/or any suitable non-volatile storage device, such as Hard Disk Drive (HDD), Compact Disc (CD) drive, Digital Versatile Disc (DVD) drive.

The NVM 406 may include part of storage resources installed on an apparatus of electronic device 400, or may be accessed by the device but not necessarily part of the device. For example, the NVM 406 may be accessed over the network via the network interface 410.

In some embodiments, the system memory 404 and the NVM 406 may include temporary and permanent copies of instructions 420, respectively. The instructions 420 may include instructions that, when executed by at least one of the processors 402, cause the electronic device 400 to implement the methods shown in FIGS. 2 to 3. In some embodiments, the instructions 420, hardware, firmware, and/or software components thereof may additionally/alternatively be in the system motherboard 408, the network interface 410, and/or the processor 402.

The network interface 410 may include a transceiver for providing a radio interface for the electronic device 400 to communicate with any other suitable device (e.g., a front-end module, an antenna, etc.) over one or more networks. In some embodiments, the network interface 410 may be integrated in other components of the electronic device 400. For example, the network interface 410 may be integrated in at least one of the processor 402, the system memory 404, the NVM 406, and a firmware device (not shown) having instructions that, when executed by at least one of the processors 402, the electronic device 400 implements one or more embodiments shown in FIGS. 2 to 4.

The network interface 410 may further include any suitable hardware and/or firmware to provide a multiple-input multiple-output radio interface. For example, the network interface 410 may be a network adapter, a wireless network adapter, a telephone modem, and/or a wireless modem.

In an embodiment, at least one of the processors 402 may be packaged with one or more controllers for the system board 408 to form a system in package (SiP). In an embodiment, at least one of the processors 402, together with one or more controllers for the system board 408, may be integrated on the same chip to form a system on a chip (SoC).

The electronic device 400 may further include an input/output (I/O) device 412 connected to the system motherboard 408. The I/O device 412 may include a user interface that enables a user to interact with the electronic device 400. Interfaces for peripheral components are further designed to enable the peripheral components to interact with the electronic device 400. In some embodiments, the electronic device 400 further includes a sensor for determining at least one of environmental conditions and location information related to the electronic device 400.

In some embodiments, the I/O device 412 may include, but is not limited to, a display (e.g., a liquid crystal display, a touch screen display, etc.), a speaker, a microphone, one or more cameras (e.g., a still-image camera and/or video camera), a flashlight (e.g., an LED flash) and a keyboard.

In some embodiments, the interfaces for peripheral components may include, but are not limited to, a non-volatile memory port, an audio jacks, and a power interface.

In some embodiments, sensors may include, but are not limited to, a gyroscope sensor, an accelerometer, a proximity sensor, an ambient light sensor, and a positioning unit. The positioning unit may also be part of the network interface 410 or may interact with the network interface 410 to communicate with components of the positioning network (e.g., Global Positioning System (GPS) satellites).

It may be understood that the structure illustrated in the embodiments of the present application does not constitute a specific limitation on the electronic device 400. In other embodiments of the present application, the electronic device 400 may include more or less components than those shown in the figures, or some combined components, some detached components, or arrangements of different components. The illustrated components may be implemented in hardware, software, or a combination of software and hardware.

Program codes may be applied to input instructions, to perform the functions described in the present application and generate output information. Output information may be applied to one or more output devices in a known manner. For realizing the purpose of this application, a system including the processor 402 for processing instructions includes any system having a processor such as a digital signal processor (DSP), a microcontroller, an application specific integrated circuit (ASIC), or a microprocessor.

The program codes may be implemented in a high-level procedural language or an object-oriented programming language, to communicate with the processing system. When necessary, an assembly language or a machine language may also be used to implement the program codes. In fact, the mechanisms described in this application are not limited to the scope of any programming language. In either case, the language may be a compiled or interpreted language.

One or more aspects of at least one embodiment may be implemented by instructions stored in a computer-readable storage medium, which when read and executed by the processor, enable the electronic device to implement the methods of the embodiments described in the application.

The present application also provides a computer-readable storage medium having computer-executable instructions stored thereon. The instructions, when executed by a processor, cause the processor to implement the embodiments of the method of the present application above.

The present application also provides a computer program product, which includes computer-executable instructions. The instructions, when executed by a processor, cause the processor to implement the embodiments of the method of the present application above.

Although the present application has been illustrated and described with reference to some embodiments thereof, it should be understood that for those of ordinary skill in the art, various formal and detailed changes may be made without departing from the spirit and scope of the present application.

What is claimed is:

1. A method for controlling movement of virtual object, comprising:
a determining step of determining, by a client, relative orientation parameters between a first virtual object and a second virtual object based on a second position-parameter and a second movement parameter of the second virtual object; the relative orientation parameters comprising an instantaneous distance and an instantaneous angle-difference between the first virtual object and the second virtual object, and the second movement parameter comprising a second instantaneous speed of the second virtual object;
a calculating step of calculating, by the client, first movement parameters of the first virtual object, based on the instantaneous distance, the instantaneous angle-difference and the second instantaneous speed; the first movement parameters comprising a first instantaneous speed and a first instantaneous angular speed of the first virtual object; and
a presenting step of controlling, by the client, the first virtual object to move toward the second virtual object based on the first instantaneous speed and the first instantaneous angular speed.

2. The method of claim 1, wherein the calculating step further comprises calculating, by the client, the first instantaneous speed based on a formula: V₁ᵢ=V₂ᵢ+dᵢ×a, wherein V₁ᵢ denotes the first instantaneous speed, V₂ᵢ denotes the second instantaneous speed, dᵢ denotes the instantaneous distance, and a denotes an acceleration coefficient, and the acceleration coefficient is used as a configuration parameter for adjusting the first instantaneous speed.

3. The method of claim 1, wherein:
the relative orientation parameters further comprise a following distance between the first virtual object and the second virtual object; and
the calculating step further comprises, calculating, by the client, the first instantaneous speed based on a formula: V₁ᵢ=V₂ᵢ+(dᵢ−d_{f})×a, wherein V₁ᵢ denotes the first instantaneous speed, V₂ᵢ denotes the second instantaneous speed, dᵢ denotes the instantaneous distance, a denotes an acceleration coefficient, and d_{f} denotes the following distance; and the acceleration coefficient and the following distance are used as configuration parameters for adjusting the first instantaneous speed.

4. The method of claim 1, wherein:
the relative orientation parameters further comprise a following distance between the first virtual object and the second virtual object;
the determining step further comprises determining, by the client, a first constraint parameter of the first virtual object, and the first constraint parameter comprises a maximum first instantaneous speed of the first virtual object; and
the calculating step further comprises, calculating, by the client, the first instantaneous speed based on a formula: V₁ᵢ=V₂ᵢ+min(dᵢ−d_{f})×a, (V_{1i_max}−V₂ᵢ), wherein V₁ᵢ denotes the first instantaneous speed, V₂ᵢ denotes the second instantaneous speed, dᵢ denotes the instantaneous distance, d_{f} denotes the following distance, and α denotes an acceleration coefficient, V_{1i_max} denotes the maximum first instantaneous speed, and a function min((dᵢ−d_{f})×a, (V_{1i_max}−V₂ᵢ)) denotes a smaller one of (dᵢ−d_{f})×a and (V_{1i_max}−V₂ᵢ).

5. The method of claim 1, wherein:
the relative orientation parameters further comprise a following distance between the first virtual object and the second virtual object;
the determining step further comprises determining, by the client, first constraint parameters of the first virtual object, and the first constraint parameters comprise a maximum first instantaneous speed of the first virtual object and a minimum first instantaneous speed of the first virtual object; and
the calculating step further comprises, calculating, by the client, the first instantaneous speed based on a formula: V₁ᵢ=max((V₂ᵢ+min((dᵢ−d_{f})×a, (V_{1i_max}−V₂ᵢ))), V_{1i_min}), wherein V₁ᵢ denotes the first instantaneous speed, V₂ᵢ denotes the second instantaneous speed, dᵢ denotes the instantaneous distance, d_{f} denotes the following distance, and a denotes the acceleration coefficient, V_{1i_max} denotes the maximum first instantaneous speed, V_{1i_min} denotes the minimum first instantaneous speed, a function min((dᵢ−d_{f})×a, (V_{1i_max}−V₂ᵢ)) denotes a smaller one of (dᵢ−d_{f})×a and (V_{1i_max}−V₂ᵢ), and a function max((V₂ᵢ+min((dᵢ−d_{f})×a, (V_{1i_max}−V₂ᵢ))), V_{1i_min}) denotes a larger one of (V₂ᵢ+min((dᵢ−d_{f})×a, (V_{1i_max}−V₂ᵢ))) and the minimum first instantaneous speed V_{1i_min}.

6. The method of claim 1, wherein the calculating step further comprises, calculating by the client, the first instantaneous angular speed based on a formula: w₁ᵢ=Δαᵢ×s, wherein w₁ᵢ denotes the first instantaneous angular speed, Δαᵢ denotes the instantaneous angle-difference, and s denotes a steering coefficient, and the steering coefficient is used as a configuration parameter for adjusting the first instantaneous angular speed.

7. The method of claim 1, wherein:
the determining step further comprises determining, by the client, a first constraint parameter of the first virtual object; the first constraint parameter comprises a maximum first instantaneous angular speed of the first virtual object; and
the calculating step further comprises, calculating, by the client, the first instantaneous angular speed based on a formula: w₁ᵢ=min(Δαᵢ×s, w_{1i_max}), wherein w₁ᵢ denotes the first instantaneous angular speed, Δαᵢ denotes the instantaneous angle-difference, s denotes a steering coefficient, w_{1i_max} denotes the maximum first instantaneous angular speed, a function min(Δαᵢ×s, w_{1i_max}) denotes a smaller one of Δαᵢ×s and w_{1i_max}.

8. The method of claim 1, wherein:
the calculating step further comprises calculating, by the client, a first inclination parameter of the first virtual object based on the first instantaneous angular speed; the first inclination parameter comprises a first instantaneous inclination-angle of the first virtual object; and
the presenting step further comprises controlling, by the client, the first virtual object to incline toward the second virtual object based on the first instantaneous inclination-angle.

9. The method of claim 8, wherein the calculating step further comprises calculating, by the client, the first instantaneous inclination-angle based on a formula: α₁ᵢ=min(w₁ᵢ×c, 90°), wherein α₁ᵢ denotes the first instantaneous inclination-angle, w₁ᵢ denotes the first instantaneous angular speed, c denotes an inclination coefficient, a function min(w₁ᵢ×c, 90°) denotes a smaller one of w₁ᵢ×c and 90°, and the inclination coefficient is used as a configuration parameter for adjusting the first instantaneous inclination-angle.

10. The method of claim 1, wherein:
the second position-parameter comprises a second instantaneous position of the second virtual object;
the determining step further comprises:
determining, at every moment by the client, a first instantaneous position and a first instantaneous orientation of the first virtual object, the first instantaneous orientation being a facing direction of a head of the first virtual object;
determining, by the client, the instantaneous distance and an instantaneous relative orientation between the first virtual object and the second virtual object based on the first instantaneous position of the first virtual object and the second instantaneous position of the second virtual object at a current moment; the instantaneous relative orientation being an orientation formed by a straight line connected between the first virtual object and the second virtual object; and
determining, by the client, the instantaneous angle-difference between the first virtual object and the second virtual object, based on the first instantaneous orientation of the first virtual object and the relative instantaneous orientation between the first virtual object and the second virtual object at the current moment; the instantaneous angle-difference being an angle formed by the first instantaneous orientation and the relative instantaneous orientation.

11. The method of claim 4, wherein the determining step further comprises determining, by the client, the following distance based on a determination rule preset in a game program executed on the client.

12. The method of claim 5, wherein the determining step further comprises:
determining a maximum moving speed of the first virtual object as the maximum first instantaneous speed thereof; and
determining a minimum moving speed of the first virtual object as the minimum first instantaneous speed thereof.

13. The method of claim 7, wherein the determining step further comprises determining a maximum rotation angular speed of the first virtual object as the maximum first instantaneous angular speed thereof.

14. A system for controlling movement of virtual object, comprising:
a determining circuit configured to determine relative orientation parameters between a first virtual object and a second virtual object based on a second position-parameter and a second movement parameter of a second virtual object, the relative orientation parameters comprising an instantaneous distance and an instantaneous angle-difference between the first virtual object and the second virtual object, and the second movement parameter comprising a second instantaneous speed of the second virtual object;
a calculation circuit configured to calculate first movement parameters of the first virtual object, based on the instantaneous distance, the instantaneous angle-difference and the second instantaneous speed; the first movement parameters comprising a first instantaneous speed and a first instantaneous angular speed of the first virtual object; and
a presenting circuit configured to control the first virtual object to move toward the second virtual object based on the first instantaneous speed and the first instantaneous angular speed.

15. An electronic device, being the client and comprising a processor and a memory storing computer-executable instructions, wherein the processor is configured to execute the computer-executable instructions to perform the method for controlling movement of virtual object of claim 1.

16. A non-transitory computer-readable storage medium, having computer-executable instructions stored thereon, wherein, the computer-executable instructions, when executed by a processor, cause the processor to perform the method for controlling movement of virtual object of claim 1.

17. A computer program product, comprising computer-executable instructions, wherein, the computer-executable instructions, when executed by a processor, cause the processor to perform the method for controlling movement of virtual object of claim 1.
